(19) United States
(12) Patent Application Publication
(10) Pub. No.: US 2025/0323526 A1
(43) Pub. Date: Oct. 16, 2025

(54) WIRELESSLY CHARGEABLE MOUSE PAD AND COIL MODULE THEREOF

(71) Applicant: DONGGUAN PADMAT RUBBER CO., LTD., DONGGUAN (CN)

(72) Inventor: Yu ZHOU, DONGGUAN (CN)

(21) Appl. No.: 18/635,061

(22) Filed: Apr. 15, 2024

(51) Int. Cl. H02J 50/00; G06F 3/039; H02J 50/10

(52) U.S. Cl. CPC H02J 50/005; G06F 3/0395; H02J 50/10

(57) ABSTRACT

A wirelessly chargeable mouse pad (10) includes a first pad plate (1), a second pad plate (2), and a coil module (3). The coil module (3) is sandwiched between the first pad plate (1) and the second pad plate (2) and includes a fabric element (31), an induction coil (32), a lead wire (33) and a sewing wire (34). The fabric element (31) has a first face (311) and a second face (312), and is disposed with multiple through holes (313). The induction coil (32) is superposed on the first face (311). The lead wire (33) is disposed on the second face (312). The sewing wire (34) is wound about the induction coil (32) and penetrates through the through holes (313) to be tied with the lead wire (33) so that the induction coil (32) is sewed on the fabric element (31).

### BACKGROUND

### Technical Field

The disclosure relates to a mouse pad structure, and particularly to a wirelessly chargeable mouse pad and a coil module thereof.

### Related Art

A wireless optical mouse, which has no wire connecting to a computer, is not restricted by a wire and can be freely slid, so it is popular in the public. However, the drawback of a wireless optical mouse is to consume more electric power than a mechanic mouse.

Thus, there is a mouse pad with a wireless charge function in the market. It uses a coil buried in the mouse pad to wirelessly charge the battery of the wirelessly chargeable optical mouse to solve the problem of the battery power consumption of the wireless optical mouse.

However, such a mouse pad needs to be disposed with multiple grooves to accommodate a coil, but the grooves disposed in a mouse pad will increase the manufacturing costs and the grooves will cause an uneven thickness to make the operating surface of the mouse pad uneven so as to result in problems of high manufacturing costs and defective finished products.

In view of this, the inventors have devoted themselves to the above-mentioned prior art, researched intensively and cooperated with the application of science to try to solve the above-mentioned problems. Finally, the invention which is reasonable and effective to overcome the above drawbacks is provided.

### SUMMARY

The disclosure provides a wirelessly chargeable mouse pad and a coil module thereof, which uses the induction coil sewed on the fabric element and the fabric element sandwiched between the first pad plate and the second pad plate to accomplish advantages of reducing the manufacturing costs and increasing the yield rate of finished products.

In an embodiment of the disclosure, the disclosure provides a wirelessly chargeable mouse pad, which includes a first pad plate, a second pad plate, a coil module and a surface layer. The coil module is sandwiched between the first pad plate and the second pad plate and includes a fabric element, an induction coil, a lead wire and a sewing wire. The fabric element has a first face and a second face, which are opposite to each other, and is disposed with multiple through holes penetrating through the first face and the second face. The induction coil is superposed on the first face. The lead wire is disposed on the second face and arranged correspondingly to the induction coil. The sewing wire is wound about the induction coil and penetrates through the multiple through holes to be tied with the lead wire so that the induction coil is sewed on the fabric element. The surface layer is covered on a surface of the first pad plate, which is away from the coil module.

In an embodiment of the disclosure, the disclosure provides a coil module of a wirelessly chargeable mouse pad, which includes a fabric element, an induction coil, a lead wire and a sewing wire. The fabric element includes a first face and a second face, which are opposite to each other, and disposed with multiple through holes penetrating through the first face and the second face. The induction coil is superposed on the first face. The lead wire is disposed on the second face and arranged correspondingly to the induction coil. The sewing wire is wound about the induction coil and penetrates through the multiple through holes to be tied with the lead wire so that the induction coil is sewed on the fabric element.

Accordingly, the disclosure uses the induction coil sewed on the fabric element by the lead wire and the sewing wire and the coil module sandwiched between the first pad plate and the second pad plate to replace the manufacturing process of a related-art mouse pad which is disposed with multiple grooves to accommodate the coil to accomplish advantages of reducing the manufacturing costs and increasing the yield rate of finished products.

### BRIEF DESCRIPTION OF THE DRAWINGS

FIG. 1 is a top schematic view of the coil module of the disclosure;

FIG. 2 is a partially enlarged top schematic view of the coil module of the disclosure;

FIG. 3 is a partially enlarged perspective schematic view of the coil module of the disclosure;

FIG. 4 is a cross-sectional schematic view of the coil module of the disclosure;

FIG. 5 is a perspective assembled view of the wirelessly chargeable mouse pad of the disclosure; and

FIG. 6 is a cross-sectional schematic view of the wirelessly chargeable mouse pad of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

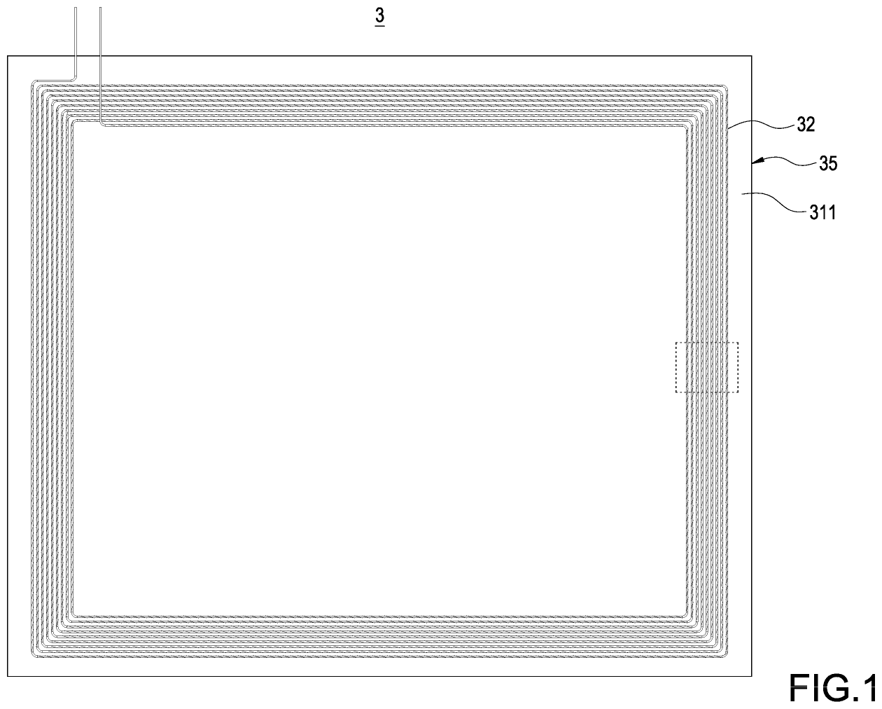

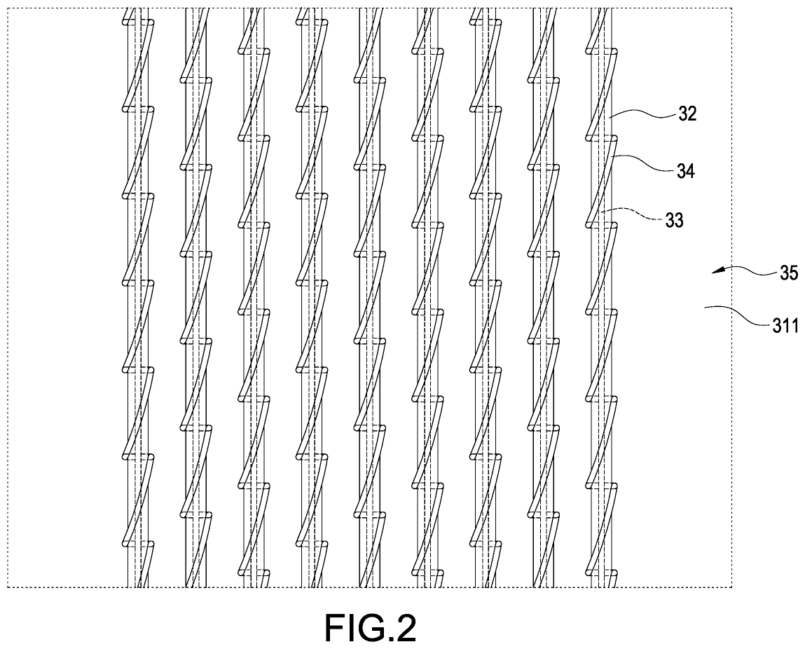

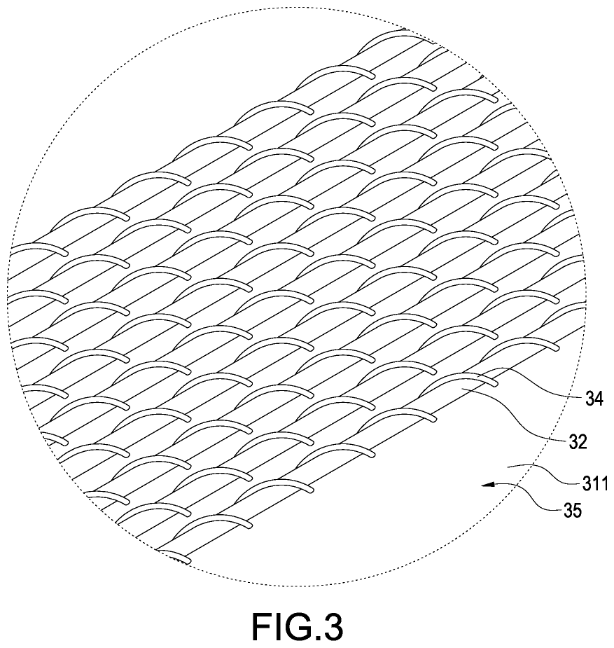

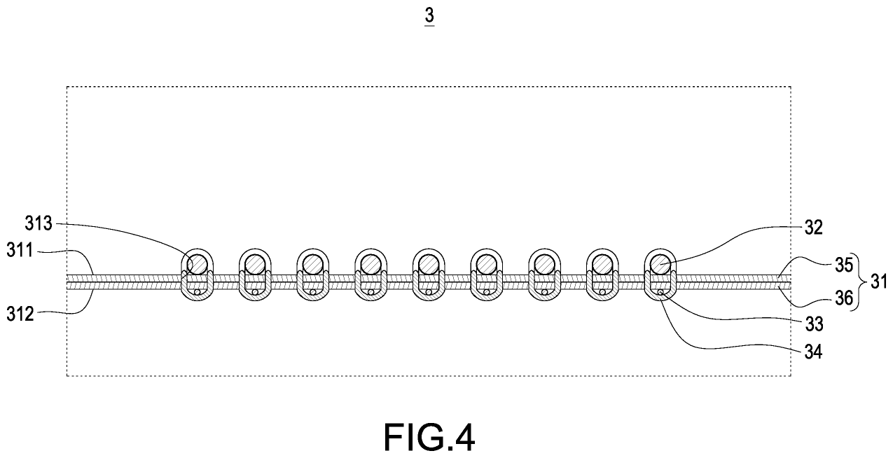

Please refer to FIGS. 1-6. The disclosure provides a wirelessly chargeable mouse pad and a coil module thereof. The wirelessly chargeable mouse pad mainly includes a first pad plate 1, a second pad plate 2, a coil module 3 and a surface layer 4. The coil module 3 mainly includes a fabric element 31, an induction coil 32, a lead wire 33 and a sewing wire 34.

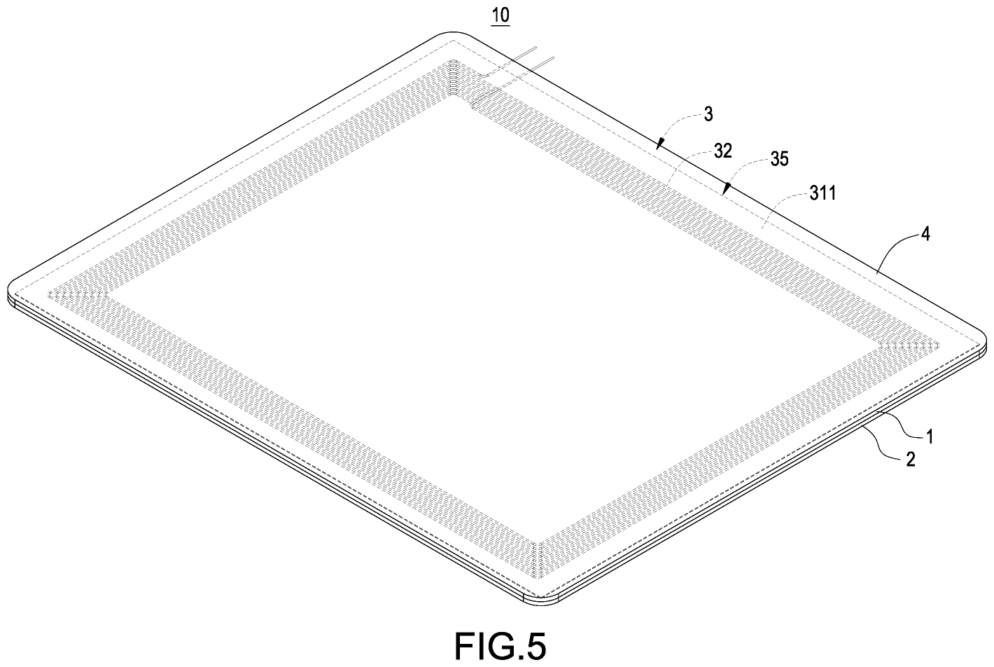

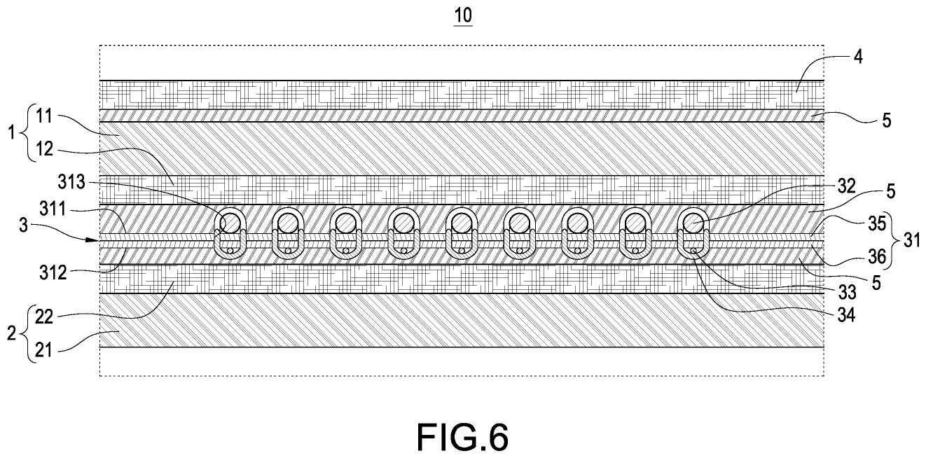

As shown in FIGS. 5 and 6, the first pad plate 1 and the second pad plate 2 may be made of the same material or different materials. The first pad plate 1 includes a first substrate 11 and a first fabric layer 12. The second pad plate 2 includes a second substrate 21 and a second fabric layer 22. Each of the first substrate 11 and the second substrate 21 can be made of one of rigid plastic, silicone, rubber, thermoplastic rubber (TPE), thermoplastic polyurethane (TPU), ethylene/vinyl acetate copolymer (EVA) and plastic foam material. The first fabric layer 12 and the second fabric layer 22 are separately formed by a textile fabric.

As shown in FIGS. 1-6, the coil module 3 includes a fabric element 31, an induction coil 32, a lead wire 33 and a sewing wire 34. The fabric element 31 is sandwiched between the first pad plate 1 and the second pad plate 2 so as to make the coil module 3 sandwiched between the first pad plate 1 and the second pad plate 2.

In addition, the fabric element 31 has a first face 311 and a second face 312, which are opposite to each other, and is disposed with multiple through holes 313 penetrating through the first face 311 and the second face 312. In detail, the fabric element 31 includes a fabric body 35 and an interlining 36, which are laminated. The first face 311 is formed on a surface of the fabric body 35, which is away from the interlining 36. The second face 312 is formed on a surface of the interlining 36, which is away from the fabric body 35. The multiple through holes 313 are disposed on the fabric body 35 and the interlining 36. The fabric body 35 is made of a textile fabric. The interlining 36 is made of a nonwoven fabric.

In addition, the induction coil 32 is superposed on the first face 311. The induction coil 32 is formed by winding a copper wire or a woven copper wire to be a loop shape. When the induction coil 32 is electrified, it can charge a wirelessly chargeable mouse (not shown in the figures) by the electromagnetic effect.

Also, the lead wire 33 is disposed on the second face 312 and arranged correspondingly to the induction coil 32. The sewing wire 34 is wound about the induction coil 32 and penetrates through the multiple through holes 313 to be tied with the lead wire 33 so that the induction coil 32 is sewed on the fabric element 31.

The surface layer 4 is covered on a surface of the first pad plate 1, which is away from the coil module 3. The surface layer 4 is made of a textile fabric or a plastic film. The surface layer 4 is used to let a mouse smoothly slide on its surface. The surface layer 4 may also have a pattern (not shown) to decorate the wirelessly chargeable mouse pad 10.

As shown in FIG. 6, the wirelessly chargeable mouse pad 10 of the disclosure further includes three adhesive layers 5. One of the adhesive layers 5 is disposed between the fabric body 35 and the first pad plate 1, another adhesive layer 5 is disposed between the interlining 36 and the second pad plate 2, and the remaining adhesive layer 5 is disposed between the surface layer 4 and the first pad plate 1 to make both the coil module 3 adhered between the first pad plate 1 and the second pad plate 2 and the surface layer 4 adhered on a surface of the first pad plate 1, which is away from the coil module 3.

In detail, in the embodiment, one adhesive layer 5 is disposed between the fabric body 35 and the first fabric layer 12, and another adhesive layer 5 is disposed between the interlining 36 and the second fabric layer 22, so as to improve the connective firmness of the fabric body 35 and the first pad plate 1 and the connective firmness of the interlining 36 and the second pad plate 2.

In addition, the first pad plate 1 can omit the first fabric layer 12 depending on situations, and the second pad plate 2 can omit the second fabric layer 22 depending on situations, so that one adhesive layer 5 is disposed between the fabric body 35 and the first substrate 11 and another adhesive layer 5 is disposed between the interlining 36 and the second substrate 21. The difference is that the firmness of the adhesive layer 5 directly attached on the first fabric layer 12 and the second fabric layer 22 is better than the firmness of the adhesive layer 5 directly attached on the first substrate 11 and the second substrate 21 only.

The production of the wirelessly chargeable mouse pad 10 of the disclosure is not limited by the embodiment shown in FIGS. 5-6. The first pad plate 1 and the second pad plate 2 of the wirelessly chargeable mouse pad 10 of the disclosure may also be integratedly formed into one piece. The first pad plate 1 and the second pad plate 2 may also sheathe outside the coil module 3 by the plastic one-piece injection molding. The surface layer 4 may also be coated on a surface of the first pad plate 1 by printing, which is away from the coil module 3.

As shown in FIGS. 1-6, when using the wirelessly chargeable mouse pad 10 and the coil module 3 of the disclosure, it uses the induction coil 32 sewed on the fabric element 31 by the lead wire 33 and the sewing wire 34 of the coil module 3 and the coil module 3 sandwiched between the first pad plate 1 and the second pad plate 2 to replace the manufacturing process of a related-art mouse pad which is disposed with multiple grooves to accommodate the coil to solve the problems of high manufacturing costs and defective finished products to accomplish advantages of reducing the manufacturing costs and increasing the yield rate of finished products.

While this disclosure has been described by means of specific embodiments, numerous modifications and variations could be made thereto by those skilled in the art without departing from the scope and spirit of this disclosure set forth in the claims.

What is claimed is:

1. A wirelessly chargeable mouse pad comprising:
a first pad plate (1);
a second pad plate (2);
a coil module (3), sandwiched between the first pad plate (1) and the second pad plate (2), and comprising:
a fabric element (31), comprising a first face (311) and a second face (312), which are opposite to each other, and disposed with multiple through holes (313) penetrating through the first face (311) and the second face (312);
an induction coil (32), superposed on the first face (311);
a lead wire (33), disposed on the second face (312), and arranged correspondingly to the induction coil (32); and
a sewing wire (34), wound about the induction coil (32), and penetrating through the multiple through holes (313) to be tied with the lead wire (33) so that the induction coil (32) is sewed on the fabric element (31); and
a surface layer (4), covered on a surface of the first pad plate (1), which is away from the coil module (3).

2. The wirelessly chargeable mouse pad of claim 1, wherein the fabric element (31) comprises a fabric body (35) and an interlining (36), which are laminated, the first face (311) is formed on a surface of the fabric body (35), which is away from the interlining (36), the second face (312) is formed on a surface of the interlining (36), which is away from the fabric body (35), and the multiple through holes (313) are disposed on the fabric body (35) and the interlining (36).

3. The wirelessly chargeable mouse pad of claim 2, further comprising three adhesive layers (5), wherein one of the adhesive layers (5) is disposed between the fabric body (35) and the first pad plate (1), another adhesive layer (5) is disposed between the interlining (36) and the second pad plate (2), and a remaining adhesive layer 5 is disposed between the surface layer (4) and the first pad plate (1) to make both the coil module (3) adhered between the first pad plate (1) and the second pad plate (2) and the surface layer (4) adhered on a surface of the first pad plate (1), which is away from the coil module (3).

4. The wirelessly chargeable mouse pad of claim 3, wherein the first pad plate (1) comprises a first substrate (11) and a first fabric layer (12), the second pad plate (2) comprises a second substrate (21) and a second fabric layer (22), each of the first substrate (11) and the second substrate (21) is made of one of rigid plastic, silicone, rubber, thermoplastic rubber (TPE) and plastic foam material, the surface layer (4) is made of a textile fabric or a plastic film, the fabric body (35), the first fabric layer (12) and the second fabric layer (22) are separately formed by a textile fabric, the interlining (36) is made of a nonwoven fabric, one adhesive layer (5) is disposed between the fabric body (35) and the first fabric layer (12), and another adhesive layer (5) is disposed between the interlining (36) and the second fabric layer (22).

5. The wirelessly chargeable mouse pad of claim 1, wherein the induction coil (32) is formed by winding a copper wire or a woven copper wire to be a loop shape.

6. The wirelessly chargeable mouse pad of claim 1, wherein the first pad plate (1) and the second pad plate (2) sheathe outside the coil module (3) by plastic one-piece injection molding, and the surface layer (4) is coated on a surface of the first pad plate (1) by printing, which is away from the coil module (3).

7. A coil module of a wirelessly chargeable mouse pad, comprising:
a fabric element (31), comprising a first face (311) and a second face (312), which are opposite to each other, and disposed with multiple through holes (313) penetrating through the first face (311) and the second face (312);
an induction coil (32), superposed on the first face (311);
a lead wire (33), disposed on the second face (312), and arranged correspondingly to the induction coil (32); and
a sewing wire (34), wound about the induction coil (32), and penetrating through the multiple through holes (313) to be tied with the lead wire (33) so that the induction coil (32) is sewed on the fabric element (31).

8. The coil module of a wirelessly chargeable mouse pad of claim 7, wherein the fabric element (31) comprises a fabric body (35) and an interlining (36), which are laminated, the first face (311) is formed on a surface of the fabric body (35), which is away from the interlining (36), the second face (312) is formed on a surface of the interlining (36), which is away from the fabric body (35), and the multiple through holes (313) are disposed on the fabric body (35) and the interlining (36).

9. The coil module of a wirelessly chargeable mouse pad of claim 8, wherein the fabric body (35) is formed by a textile fabric, and the interlining (36) is made of a nonwoven fabric.

10. The coil module of a wirelessly chargeable mouse pad of claim 7, wherein the induction coil (32) is formed by winding a copper wire or a woven copper wire to be a loop shape.
